(19) United States
(12) Patent Application Publication
(10) Pub. No.: US 2020/0382646 A1
(43) Pub. Date: Dec. 3, 2020

(54) ENHANCED CONTROLS FOR A COMPUTER BASED ON STATES COMMUNICATED WITH A PERIPHERAL DEVICE

(71) Applicant: MICROSOFT TECHNOLOGY LICENSING, LLC, Redmond, WA (US)

(72) Inventors: Sandhya RAO, Bellevue, WA (US); Jevgeni SMOROV, Redmond, WA (US); Swathi Challkere VIJAYAPRAKASH, Redmond, WA (US); Douglas R. ANDERSON, Kirkland, WA (US)

(21) Appl. No.: 16/428,942

(22) Filed: May 31, 2019

(51) Int. Cl. H04M 3/56; H04L 12/18

(52) U.S. Cl. CPC H04M 3/56; H04M 2203/254; H04L 12/1818; H04L 12/1822

(57) ABSTRACT

A software application on a device controls a notification state of a peripheral device having a microphone, speaker and at least one button. The notification state includes one or more button press expression definitions and corresponding functions executable by the computing device. In response to receiving a sequence of button presses that satisfy a button press expression definition, the peripheral device sends a notification response causing the computing device to perform the corresponding action. The corresponding action may activate a voice assistant and make the voice assistant accessible through the peripheral device, which has fewer compute resources than are required to operate a voice assistance. In another example, the button press expression definitions can be used to control the mode in which a user enters a communication session, mute on, audio only, etc.

### BACKGROUND

Multi-user communication technology enables video conferencing, messaging, scheduling of meetings, and whiteboard collaboration. Microsoft Skype (with Business and Consumer versions) and Microsoft Teams are examples of such technology offerings in the marketplace today.

These technologies operate on computing devices that have network connectivity and considerable compute resources, such as a personal computer (PC), mobile phone, or tablet computer. While this connectivity and compute power enables many functions and features, having a large number of functions and features makes it difficult to find and make use of a particular piece of functionality.

For example, when a user wants to join an online meeting, the user may have to walk over to their desk, access their computer open a meeting application, open their calendar, scroll through the calendar to find the meeting, open the meeting, and then find and click the join meeting button. Such scenarios may even involve additional manual steps to coordinate the meeting with any peripheral devices they may be using.

In another example, when a user wants to join an online meeting using a voice command, the user may have to open a meeting application, locate a software button that activates a voice assistant, and then activate the voice assistant. Only then may the user ask the voice assistant to alert the attendees of the upcoming meeting.

Navigating a complex software user interface as described above is tedious, wastes computing resources, and is error-prone. For example, manually searching the calendar makes it possible for the user to inadvertently join the wrong meeting. This type of navigation is highly inefficient with respect to the user's productivity and computing resources.

It is with respect to these and other considerations that the disclosure made herein is presented.

### SUMMARY

The technologies described herein provide improved computer-implemented techniques for interacting with client applications. In some configurations, a peripheral device (hereinafter also referred to as a “peripheral”) has a button that can be pressed to activate an action of the client application. The peripheral may have an exclusive data connection with the computer that is running the client application, and the peripheral may have fewer compute resources or network resources than are required to perform the action. In some configurations, the peripheral device in communication with the computing system can be utilized to provide notifications, such as visual text or lights, to provide a status of a meeting. The user can use unique button press expressions to control the mode in which they can enter the meeting. For example, a double button press can enter a meeting in a mute mode, a single button press can enter a meeting in a full video and audio mode, etc. In other configurations, the peripheral can be utilized to access voice assistant features of an application.

Aspects described herein provide technological solutions to technological problems. For example, it is a technological problem to expose functionality of a software application in a seamless and intuitive manner. This technological problem is amplified as the number of features in the software application increases, as each additional feature consumes screen real-estate, cluttering and obscuring other features. To solve this problem, aspects described herein utilize a physical button on a physical peripheral device to directly invoke an action on a computing device. In this way, select features can be invoked without navigating a cluttered or complicated software user interface. This improves on conventional user interfaces to increase the efficiency of using a software application. These aspects also improve the efficiency of the computing device by reducing the amount of processing used to navigate a user interface, and by off-loading user interface functionality to a more computationally efficient peripheral device.

In some configurations, the peripheral receives a notification message from the computing device (also referred to herein as a “notification”). In some configurations, the notification message indicates a state of the application. For example, the notification message may indicate that a meeting is about to start, that a meeting has just started, that a voicemail has been missed, that a call has been missed, etc. In response to the notification message, the peripheral may enter a notification state. While in the notification state, the peripheral may provide a visual or audible indication of the notification state, such as displaying text or emanating an audio signal that describes the notification state. For example, the notification message may indicate that a meeting has just started, or that a voice call was missed. The peripheral may also cause the button to illuminate while in the notification state—e.g. a light on the button may be made to pulse on and off. The peripheral may also cause the text description of the notification state to flash on and off.

The notification state may also determine what action the client application will perform when the user presses the button. For example, when a notification indicates that a meeting has just started, pressing the button may cause the client application to join the meeting without further interaction, sign-in, or login from the software application.

The notification state may timeout after a period of time, or in response to an event. For example, the notification state may timeout after a period of time defined by the notification. The notification state may also end because the underlying cause of the notification (e.g. a meeting) has ended, or when the notification is superseded by another notification. Once the peripheral leaves the notification state, the button ceases to be lit, and the action associated with the button reverts to a default action.

In some configurations, the button supports different predetermined button press expressions—short presses, long presses, patterned presses, etc. Different expressions may cause different actions to be performed by the client application. Some expressions may perform an action based on the notification state, while other expressions may be universal—i.e. independent of the notification state. In some configurations, a long press requests access to voice skills provided by the client application. Once the long press has been registered, the user may speak into a microphone on the peripheral. The resulting audio may be transmitted to the computing device for processing by a voice assistant, utilizing the compute and networking resources of the computing device. If the voice assistant has an audio response, the audio response may be transmitted back to the peripheral and broadcast or otherwise emanated by a speaker. In this way, the user is able to utilize voice skills in locations where they might not otherwise be accessible or practical. Furthermore, voice skills may be utilized with a device that contains less compute power than smart speakers, computers, mobile phones, etc.

In some configurations, a button press expression may be associated with performing the action in a predetermined mode. For example, a single button press may cause an upcoming meeting to be joined in a default mode, while a double button press may cause the upcoming meeting to be joined with the peripheral device in a mute mode. Other button press expressions may cause the meeting to be joined in a web cam mode, while another button press expression may cause the meeting to be joined in an audio only mode.

The techniques described herein can lead to more efficient use of computing systems. In particular, by simplifying the controls used for certain actions, such as a user joining a meeting, user interaction with the computing device can be improved. The techniques disclosed herein can eliminate a number of manual steps that require additional computing resources. For instance, for a person to join a meeting where a peripheral device is not used, a user has to directly access a computer and perform a number of steps to join a meeting or to activate certain modes of an on-line meeting. This causes a computing device to use a number of computing resources, including memory resources and processing resources, perform all of those steps. Elimination of these manual steps leads to more efficient use of computing resources such as memory usage, network usage, and processing resources, since it eliminates the need for a person to retrieve, render both audio and video data, and review the rendered data. In addition, the reduction of manual data entry and improvement of user interaction between a human and a computer can result in a number of other benefits. For instance, by reducing the need for manual entry, inadvertent inputs and human error can be reduced. Fewer manual interactions and a reduction of inadvertent inputs can avoid the consumption of computing resources that might be used for correcting or reentering data created by inadvertent inputs.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithm(s), hardware logic, and/or operation(s) as permitted by the context described above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 illustrates an exemplary communication session arrangement that includes a computing device and a peripheral device.

FIG. 2A illustrates operation of an exemplary communication session arrangement that includes a software application sending a notification message to a peripheral device, causing the peripheral device to enter a default state.

FIG. 2B illustrates operation of the exemplary communication session arrangement that includes a peripheral device in a default state receiving a single short button press and sending a notification response to a software application, causing the software application to bring itself into the foreground.

FIG. 2C illustrates operation of the exemplary communication session arrangement that includes a peripheral device in a default state receiving a single long button press and sending a notification response to a voice assistant within an application.

FIG. 2D illustrates operation of the exemplary communication session arrangement that includes a voice assistant of an application transmitting a voice assistant audio prompt to a peripheral device.

FIG. 2E illustrates operation of the exemplary communication session arrangement that includes a peripheral device transmitting a voice assistant command to a voice assistant running within an application.

FIG. 2F illustrates operation of the exemplary communication session arrangement that includes a voice assistant transmitting a voice assistant response to a peripheral device.

FIG. 3A illustrates operation of the exemplary communication session arrangement that includes a software application sending a notification message to a peripheral device, causing the peripheral device to enter a meeting notification state.

FIG. 3B illustrates operation of the exemplary communication session arrangement that includes a peripheral device in a meeting notification state receiving a single short button press and sending a notification response to a software application, causing the software application to open a join meeting window.

FIG. 3C illustrates operation of the exemplary communication session arrangement that includes a peripheral device in a meeting notification state receiving a double short button press and sending a notification response to a software application, causing the software application to join a meeting.

FIG. 4 is a diagram illustrating aspects of a routine related to notification messages exchanged between a computing device and a peripheral device.

FIG. 5 is a computer architecture diagram showing an illustrative computer hardware and software architecture for a computing device that can implement the various technologies presented herein.

FIG. 6 is a network diagram illustrating a network computing environment in which aspects of the disclosed technologies can be implemented, according to various embodiments presented herein.

### DETAILED DESCRIPTION

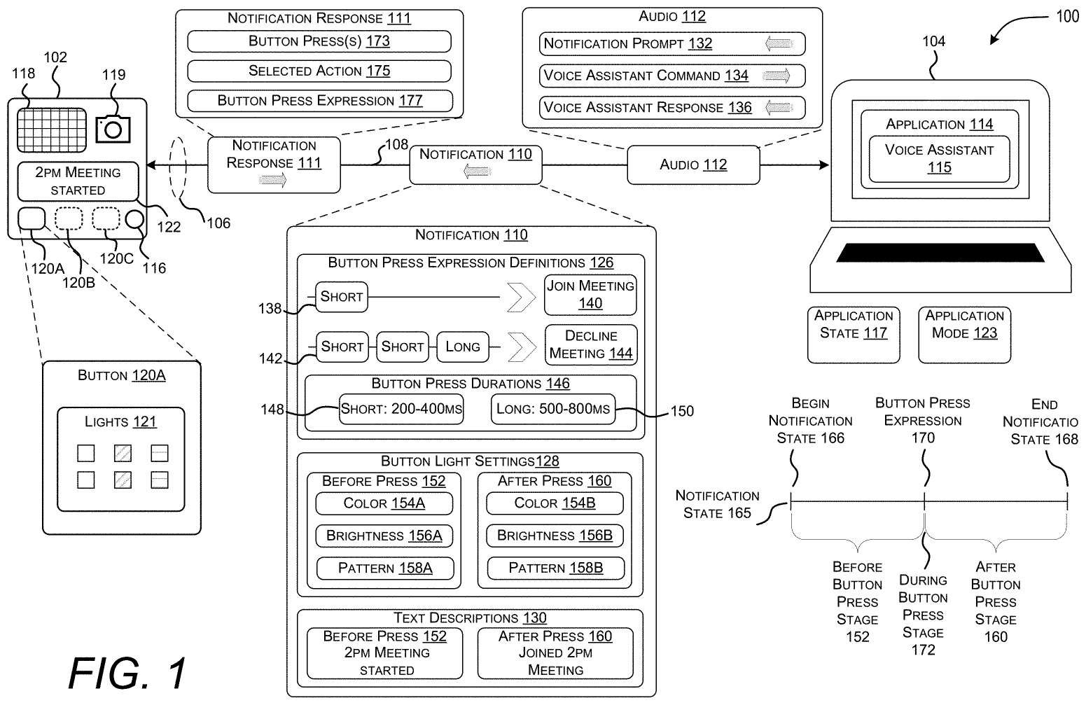

FIG. 1 illustrates an exemplary communication session arrangement 100 that includes a peripheral device 102 and a computing device 104. In some implementations, peripheral device 102 is a speakerphone and computing device 104 is a personal computer. In other implementations, peripheral device 102 is a headset, keyboard, mouse, video camera 119 (e.g. a “webcam”), computer monitor, smart watch, smart home product (e.g. a smart light switch, smart thermostat, etc.), head unit in a vehicle or any other portion of the vehicle, television, television remote, or any other physical device that is communicatively coupled to computing device 104 and that allows users to hear and speak to one or more participants associated with a communication session. Computing device 104, in some configurations, may be representative of a tablet, mobile phone, laptop, or any other suitable computing and/or communication device.

Peripheral device 102 may include at least a microphone 116, speaker 118, camera 119, one or more buttons 120A-120C, and/or graphical display 122. Buttons 120A-120C may be adorned with lights 121, e.g. one or more light emitting diodes (LEDs) capable of emitting different colors of light. Peripheral device 102 may initiate or establish a connection with application 114 running on computing device 104. In some configurations, peripheral device 102 establishes the connection with a single application 114, even though other applications may also be executing on computing device 104. By connecting with a single application, user interaction with peripheral device 102 unambiguously affects that single application, streamlining and optimizing interactions with the single application. In this configuration, while peripheral device 102 is connected to one application at a time, the application that peripheral device 102 is connected to may be changed, such that user interaction with peripheral device 102 would affect the other application. In this way, different applications can take advantage of the streamlined user interface provided by peripheral device 102.

In some configurations, peripheral device 102 may be purpose built to function with a particular type of application or even a specific application. For example, peripheral device 102 may be built to interact with an email application, or specifically, the Microsoft® Outlook® email application. Designing peripheral device 102 to work with particular types of applications or specific applications allows for deeper integration between the features of peripheral device 102 and the functionality of application 114. For example, a peripheral device 102 designed for use with a meeting application may include a button 120A for general purpose control, button 120B dedicated to translating a voice communication during a meeting, and a button 120C dedicated to transcribing the meeting. However, other device configurations are not designed for use with a particular application or type of application, and may be connected with any application that supports the underlying protocol. Such a general purpose device may have at least a single button 120 that receives button press sequences and which may display status or other information via lights 121.

A communication medium 106 may be used to connect computing device 104 to peripheral device 102. In some implementations, communication medium 106 includes a wireless interconnection medium that connects computing device 104 to peripheral device 102, such as near field communications (NFC) protocol, a Bluetooth protocol, a Wi-Fi protocol, or another type of wireless protocol. Alternatively, communication medium 106 may be implemented using a wireline interconnection medium, such as a universal serial bus (USB) cable, Lightning cable, ethernet cable, or the like.

In some configurations, communication medium 106 facilitates a wireless or wireline communication channel 108 that is established between peripheral device 102 and computing device 104. Communication channel 108, in some implementations, is a direct communication channel between peripheral device 102 and computing device 104. Communication channel 108 may be direct in that there are no intermediate devices between peripheral device 102 and computing device 104. Communication channel 108 may also be direct in that peripheral device 102 and computing device 104 are connected via a local network, i.e., not connected via the Internet. Such a direct communication channel may be implemented over a wireline interconnection by a USB pipe, ethernet connection, or Lightning connection. When the direct communication channel is implemented or over a wireless interconnection medium, communication channel 108 may utilize a personal area network (PAN) technology, such as Bluetooth, Wi-Fi direct, or ZigBee. In some configurations, peripheral device 102 is not connected to the Internet via communication channel 108.

In some configurations, the direct communication channel is a dedicated, persistent and secure short-range (i.e., up to 100 m range and in some implementations up to 10 m) communication channel established between peripheral device 102 and computing device 104, which are in local proximity to each other. The dedicated, persistent and short-range characteristics of the direct communication channel between peripheral device 102 and computing device 104 is advantageous because it offers a very low communication latency between peripheral device 102 and computing device 104. The low latency characteristic of the direct communication channel means that notification 110, notification responses 111, and audio 112 exchanged between peripheral device 102 and computing device 104 are processed very quickly to achieve a timely effect.

Advantageously, security of the direct communication channel between peripheral device 102 and computing device 104 is achieved because the direct communication channel is established without communicating over the Internet.

The low power consumption of the direct communication channel used between peripheral device 102 and computing device 104 is particularly advantageous when the implementation of peripheral device 102 is a mobile computing device or a battery powered device, such as a mobile phone or a Bluetooth computer mouse. The low power consumption characteristics of the direct communication channel are achieved through the use of wireline connectivity, and/or by low powered wireless signals that carry data between peripheral device 102 and computing device 104.

The communication channel 108 may be a full-duplex direct communication channel that couples peripheral device 102 and computing device 104. Alternatively, communication channel 108 may be a half-duplex direct communication channel between peripheral device 102 and computing device 104.

In some configurations, peripheral device 102 and computing device 104 are coupled together using a plurality of communication channels 108. Each of the plurality of communication channels 108 may be direct communication channels between the peripheral device 102 and the computing device 104. It may be advantageous to implement a plurality of direct communication channels between the peripheral device 102 and the computing device 104 to support latency free or near latency free simultaneous communication of audio 112, notification response 111, and notification 110 (e.g. notification state changes) between peripheral device 102 and computing device 104.

Communication channel 108 may be used for exchanging notification message 110 (also referred to as ‘notification’), notification response message 111 (also referred to as ‘notification response’), and/or audio 112. Notification 110 may be transmitted from application 114 on computing device 104 to peripheral device 102, causing peripheral device 102 to enter a notification state. In some configurations, a notification state configures peripheral device 102—including what is displayed on display 122, what lights 121 are illuminated on button(s) 120, and what actions will be activated in application 114 in response to one or more presses of button (s)120. In some configurations, notification 110 is based on an application state 117. Application state 117 may indicate whether application 114 is managing an upcoming meeting, whether a voicemail has yet to be listened to, whether a phone or video call was missed, etc.

If peripheral device 102 is already in a notification state, notification 110 may cause peripheral device 102 to exit the current notification state and enter a new notification state. Notification 110 may also cause peripheral device 102 to leave a notification state and return to a default state.

In some configurations, a notification state has multiple stages. Stages allow peripheral device 102 to exhibit different behavior at different points of time during the notification state. For example, a notification state for joining a meeting may have a “before meeting” stage, a “during meeting” stage, and an “after meeting” stage.

Stages may be defined in terms of a scheduled event, such as the beginning and ending of a meeting. Stages may also be defined in terms of user input, e.g. button press expressions. For example, a notification state associated with a missed video call may have a “before button press expression” stage, an “after button press expression” stage, or a “during button press expression” stage.

Stages may last for a defined amount of time. For example, if a notification state related to a meeting begins 15 minutes before the 2 PM meeting, the “before meeting” stage may be defined as lasting 15 minutes, from 1:45 PM to 2 PM. In another example, the notification state may have an “upcoming meeting notification stage” that lasts for 10 minutes from 1:45 PM to 1:55 PM, followed by a “prompt user to join the meeting stage” that lasts from 1:55 PM to 2 PM.

Stages may last until a particular button press expression is received. For example, when a video call has been missed, the “before button press expression” stage may last until a button press expression responding to the missed video call is received. This is depicted in FIG. 1, where a button press expression 170 is entered by a user, ending the before button press stage 152 of notification state 165. Notification state 165 also includes a during button press stage 172 while button press 170 is being received, and an after button press stage 160 between button press expression 170 and end of notification state 168. During the before button press stage 152, color 154A, brightness 156A, and pattern 158A, may be utilized. Similarly, during the after button press stage 160, color 154B, brightness 156B, and pattern 158B may be utilized.

In some configurations, stages may be defined as lasting either for a defined amount of time or until one or more particular button press expressions are received. For example, the “before button press expression” stage of a missed video call notification state may be defined as lasting 10 minutes or until the particular button press is received.

Stages may be progressed through linearly, from beginning to end, or stages may repeat, form loops, or otherwise jump from one to another. If a notification state has multiple stages, application 114 may cause the notification state to transition from one stage to the next by sending another notification 110. For example, notification 110 may cause a notification state to change from a “before meeting” stage to a “during meeting” stage. Another notification 110 may cause the notification state to change from the “during meeting” stage to a “after meeting” stage. In another configuration, notification 110 may define stages and button press expressions that dictate when and how to transition between stages for the entire notification state, allowing peripheral device 102 to manage the notification state as it progresses through stages.

When notification state 165 is associated with an external event, such as a meeting, or when a voicemail has been missed, the status of the external event may change, causing notification state 165 to be out of date. For example, the meeting may be rescheduled to a later time, or the user may listen to the voicemail on their cell phone. In these circumstances, application 114 may send another notification 110 to update notification state 165 based on the status of the external event. Notification 110 may advance notification state 165 to the next stage, advance notification state 165 to a different stage (e.g. if the stages form a loop), replace notification state 165 with a new notification state, etc.

Notification 110 may include button press expression definitions 126, button light settings 128, and/or text descriptions 130. For example, peripheral device 102 may receive a notification 110 that indicates a meeting has started. Text description 130 may include text for use by graphical display 122 that describes the notification state, e.g. that the user's 2 PM meeting has started. In another configuration, text description 130 may describe one or more button press expression definitions 126 and the associated action. Button light settings 128 may indicate a color 154 (e.g. red), a brightness 156 (e.g. high), and/or a pattern 158 (e.g. pulsing) for one or more lights 121 of button 120. The same notification 110 may define button press expression definitions 126 that map a series of button presses to an action, e.g. a single short button press 138 that causes application 114 to perform a join meeting action 140. In some configurations, button press expression definitions 126, button light settings 128, and/or text description 130 are based on an application state 117. Application state 117 may indicate whether the user of application 114 has missed something, e.g. a voicemail is unheard, or a call has been missed, or if a meeting has just started. In some configurations, application state 117 is the basis for notification state 165.

Each of button press expression definitions 126 maps a sequence of button presses to an action to be performed by application 114. A button press sequence may define a number of button presses (e.g. 2 presses), a duration of each button press (e.g. a first press between 200 milliseconds and 400 milliseconds, and second press between 600 and 900 milliseconds), and/or an amount of time between button pushes (e.g. between 50 and 400 milliseconds between the first press and the second press).

Additionally, or alternatively, button press expression definitions 126 may be defined in terms a sequence of short presses and long presses. Short presses may be defined as having a minimum duration and maximum duration, such that holding down button 120 for longer than the minimum duration, but less than the maximum duration, registers as a press. The minimum and maximum durations may be standardized across different applications 114, customized by different applications 114, or defined by an end-user. Long presses may similarly have minimum and maximum durations that may be standardized across different applications 114, set to different durations by different applications 114, or defined by an end-user.

For example, button press expression definition 138 maps to a join meeting 140 action. Button press expression definition 138 defines a single short press, such that when a user holds button 120 down for a defined “short” duration (e.g. 200-400 milliseconds), application 114 will perform the join meeting action 140. In some configurations, peripheral device 102 causes application 114 to perform the join meeting action 140 by sending one or more notification responses 111 to computing device 104.

In some configurations, button press expression definitions 126 may include one or more button press expression definitions that cause a corresponding action to be performed in a specific application mode 123. For example, join meeting action 140 may cause the associated meeting to be joined in a default mode, while a different button press expression may cause the associated meeting to be joined in an audio only mode, e.g. a mode in which only audio is transmitted to and from other meeting participants. Other application modes associated with a meeting are similarly contemplated—e.g. a video mode, in which video captured by web cam 119 is transmitted to other meeting participants, and/or in which video of other meeting participants is received and displayed by application 114. In some configurations, a mute mode joins the meeting with peripheral device 102 muted. A projection mode may cause the meeting to be displayed on a projector attached to the computing device.

Other actions associated with other application states 117 may also be activated in particular modes. For example, when a call has been missed, a “call back” action may be activated in a speakerphone mode, which uses microphone 116 and/or speaker 118 while calling the person back. However, the “call-back” action may, via a different button press expression, be activated in a mobile phone mode in which application 114 causes a mobile phone associated with the user to call the person back.

Similarly, a missed voicemail state may associate a button press expression with an action to listen to the missed voicemail using peripheral device 102. However, other button press expressions may cause application 114 to transcribe the voicemail and send it to a mobile phone. Another button press expression may cause application 114 to translate the voicemail into the user's preferred language and play the translation over speaker 118.

In some configurations, notification response 111 includes a selected action 175 such as the join meeting action 140. In this way, in response to receiving notification response 111, application 114 performs the join meeting action 140. In this configuration, peripheral device 102 recognizes the button press expression definition 138 and transmits the corresponding action 140 to application 114, causing application 114 to perform the selected action 175.

In other configurations, application 114 identifies the button press expression and/or determines which action to take. For example, peripheral device 102 may recognize a button press sequence that satisfies a button press expression definition 138, and in response, include button press expression 177 in notification response 111. In this configuration, peripheral device 102 does not tell application 114 what action to take. In this configuration, application 114 selects the action to perform based on the button press expression 177 recognized by peripheral device 102. This configuration may be useful when the specific action to be taken depends on the state or context of application 114.

In other configurations, peripheral device 102 recognizes one or more individual button presses 173, and transmits indications of these button presses 173 and their durations to application 114 in one or more notification responses 111. In this configuration, application 114 processes the button press indications, recognizes when button press expressions have been entered, and takes the appropriate action. When peripheral device 102 transmits individual button presses 173, each button press indication may be conveyed in a separate notification response 111 or batched and conveyed in the same notification response 111. This configuration may be useful when peripheral device 102 does not have enough compute power to recognize button press expressions.

In yet another configuration, peripheral device 102 transmits a notification response 111 when button 120 has been depressed or when it has been released. Application 114 may process these button depressed/released events, recognize short and long button presses, identify when a particular button press expression has been performed, and perform the corresponding action.

Button press expression definition 142 is triggered when the following sequence is observed: short press, short press, long press. Upon recognizing this expression, peripheral device 102 may send notification response 111 to application 114, causing application 114 to perform the decline meeting 144 action.

In some configurations, button press expression definitions 126 may include hand signals, facial expressions, eye gazes, or other gestures performed the user and captured by camera 119. Button press expression definitions 126 may be defined exclusively in terms of gestures, or in combination with presses of button 120. For example, a button press expression definition may define that a “thumbs up” gesture will cause a missed voicemail to be played. In this case, in response to the user making a “thumbs up” gesture in view of camera 119, peripheral 102 will transmit a notification response 111 to computing device 104 causing the missed voicemail to be played.

Button press expression definitions 126 may also include input from a different peripheral connected to or otherwise in communication with computing device 104. For example, button press expression definitions 126 may include input from a mouse, a keyboard, a trackpad, a touch screen, or any other source of input to computing device 104. Button press expression definitions 126 may include these other sources of input in conjunction with presses of button 120, gestures captured by camera 119, or any other source of user input.

For example, one of button press expression definitions 126 may be satisfied when button 120 is pressed while a control key of a keyboard used by computing device 104 is depressed. A different one of button press expression definitions 126 may be satisfied when a control key is pressed on the keyboard, followed by button 120 being pressed, followed by a right-click of a mouse button. Still another one of button press expression definitions 126 may be satisfied when button 120 is pressed while the control key of the keyboard is pressed and while the user is performing a “thumbs up” gesture captured by video camera 119. Any other permutation of and/or sequence of different input types are similarly contemplated for button press expression definitions.

In some configurations, exemplary communication session arrangement 100 may include multiple devices in communication with computing device 104, each of which includes one or more buttons 120. For example, a mouse, keyboard, headset, web camera, monitor, another instance of peripheral device 102, or other computer peripheral may be built to include a button 120 capable of performing the functionality associated with button 120 of peripheral device 102. In these scenarios, any peripheral device with a button 120 may be used to satisfy any of button press expression definitions 126, causing an associated action to be performed by application 114. In some configurations, which device has button 120 pressed affects the action taken.

For example, which device has button 120 pressed may affect what input and/or output devices are used to perform the corresponding action. If a user is wearing a headset, and if the notification state indicates that a meeting has just started, activating button 120 on the headset may cause the meeting to be joined using the microphone and speaker on the headset. At the same time, activating button 120 of peripheral device 102 may cause microphone 116 and speaker 118 to be used. However, if a join meeting action is received from a device that is not an audio endpoint—i.e. that does not have a microphone and/or speaker, such as a keyboard or mouse, a default speaker and microphone of computing device 104 may be used.

In some configurations, when exemplary communication session arrangement 100 contains multiple devices with a button 120, and/or when a device such as peripheral device 102 includes multiple buttons 120A, 120B, etc., each button on each device may be associated with a different notification state. For example, application 114 may send a notification message 110 related to a pending meeting to peripheral device 102, while sending a notification message 110 related to an unheard voicemail to a headset. Similarly, the notification message 110 related to the meeting may be sent to peripheral device 102 to be associated with button 120A, while the notification message 110 associated with the unheard voicemail may also be sent to peripheral device 102, but to be associated with button 120B. When multiple buttons 120 are available to be pressed, application 114 may send, receive, and process the associated notification messages 110 and notification response messages 111 concurrently.

In some configurations, when multiple buttons 120 (potentially on multiple peripheral devices 102 or other devices that have a button 120) are connected with computing device 104, each button may be associated with a different application 114. For example, a button 120A may be associated with a multi-user communication technology software such as Microsoft® Teams®, while a button 120B may be associated with an email application such as Microsoft® Outlook®.

In another configuration, peripheral device 102 may enter a notification state indicating that four voicemail messages have been missed. In this case, one of button press expression definitions 126 may define that a short button press in combination with a hand signal indicating which of the four messages to play (e.g. by holding up four fingers). If the user generates a short button press while holding up four fingers, peripheral device may transmit a notification response 111 causing a “play missed voicemail” action, and specifically indicating that the fourth missed voicemail should be played.

Button press expression definitions 126 may optionally include button press durations 146. Button press durations 146 define how long button 120 must be held down to register a particular type of button press. For example, short duration 148 is defined as between 200 and 400 milliseconds. This means that a short button press will be recognized when button 120 is held down for at least 200 milliseconds but less than 400 milliseconds. Similarly, long-duration 150 is defined as between 500 milliseconds and 800 milliseconds, such that a long press will be recognized when button 120 is held down for at least 500 milliseconds but less than 800 milliseconds. The values discussed herein are examples, and any other durations similarly contemplated.

Button light settings 128 describe how lights are lit during notification state 110. For example, button light settings 128 may include one or more properties such as color 154, brightness 156, and pattern 158 to be applied to lights 121.

In some configurations, color 154 defines the color emitted by lights 121 on button 120. Color 154 may be defined in terms of red green blue (RGB), cyan magenta yellow and black (CMYK), a wavelength, or any other technique for defining a color. In some configurations, button 120 may have multiple lights 121, in which case color 154 may define a color for each light. If there are multiple lights, they may be assigned the same color, e.g. reg, or different colors, e.g. red, green, and yellow. In some configurations, specific lights are assigned specific colors. For example, lights 121 may be numbered, and color 154 may define a pattern that is applied to the numbered lights. For example, button 120 may have twenty lights numbered one through twenty. A pattern of {yellow, orange, red} may be applied, such that lights 1, 4, 7, 10, 13, 16, and 19 are set to yellow, 2, 5, 8, 11, 14, 17, and 20 are set to orange, and lights 3, 6, 9, 12, 15, and 18 are set to red.

In some configurations, brightness 156 defines an intensity of light emitted by lights 121. Brightness may be defined in relative terms, e.g. high, medium, or low. Brightness may also be defined in absolute terms, e.g. as a voltage, number of lumens, etc. Brightness 156 may be set to the same level for all of lights 121, or individual lights may be set to individual brightness levels similar to how different lights may be assigned different colors as discussed above.

In some configurations, pattern 158 defines a sequence of one or more colors and brightness values for one or more of the lights 121 on button 120. In this way, pattern 158 may create more advanced effects then turning a light 121 on to a particular color and a particular brightness. For example, pattern 158 may create a pulsating effect by repeatedly increasing and then decreasing brightness. Additionally, or alternatively, pattern 158 may cycle through colors and/or color shades, further drawing attention to button 120. Pattern 158 may remain constant or may change over the course of a stage or over the course of the entire notification state. For example, pattern 158 may slowly increase brightness 156 throughout a pre-join stage of a notification state associated with a meeting. In other configurations, pattern 158 may change after a defined amount of time has passed, e.g. pattern 158 may change ten minutes after a notification state has started.

In some configurations, color 154, brightness 156, and pattern 158 are given different values for different stages of the notification state. For example, if notification 110 is received at 1:45 PM, and if notification 110 indicates that the user has a meeting from 2 to 3 PM, notification 110 may define stages from 1:45 PM to 1:55 PM (“alert to meeting”), 1:55 PM to 2 PM (“prompt to join meeting”), 2 PM to 2:55 PM (“during meeting”), 2:55 PM to 3 PM (“meeting ends soon”), and 3 PM to 3:15 PM (“after meeting”). Notification 110 may further subdivide each of these stages based on whether a button press expression is expected to be received during that stage. For example, button light settings 128 may include an initial color 154 of “yellow”, a brightness 156 of “low”, and/or a pattern 158 of “constant” for the “alert to meeting” stage. However, the color may be changed to “green” in response to receiving a button press expression that causes the join meeting action 140.

Continuing the example, button light settings 128 may change the color and/or intensity of lights 121 if the “alert to meeting” stage is entered and a sequence of button presses satisfying one of button press expression definitions 126 causing the join meeting action 140 hasn't been received. For example, color 154 may be given a different shade (e.g. darkened) or changed to a new color entirely. Brightness 156 may be increased (or decreased). Pattern 158 may intensify (e.g. colors and/or brightness of some or all lights may be made to cycle faster or slower) or be changed completely.

In some configurations, button light settings 128 adjust some or all of color 154, brightness 156, and pattern 158 throughout a stage. For example, during the “alert to meeting” stage, button light settings 128 may continuously increase brightness from 1:55 PM until the meeting starts at 2:00 PM.

In some configurations, color is used to convey priority—e.g. a red color may indicate that the notification state is a high priority, while a yellow color may indicate that the notification state is a moderate priority, and a blue color may indicate that the notification state is a low priority. In other configurations, color shade may be used to convey priority. For example, a notification state may begin with the button emitting a light shade of red. As time goes on, the shade may darken to indicate that the notification state has gone un-responded to.

In some configurations, color may be used to convey what type of notification state peripheral device 102 is in. For example, a red color may indicate that a meeting is pending, while a purple color may indicate that a call was missed, while a orange color may indicate that an unheard voicemail is available.

Text descriptions 130 include text to be displayed on graphical display 122. As illustrated, peripheral device 102 causes graphical display 122 to display “2 PM meeting started” during the before button press stage 152. Once the after button press stage 160 has begun, peripheral device 102 may change graphical display 122 to read “Joined 2 PM meeting”. Similar to button light settings 128, text descriptions may be defined based on a stage the notification state is in, or a subdivision of a stage based on whether a particular button press expression has been received. In some configurations, text descriptions 130 describe how the user may satisfy one or more button press expression definitions and their corresponding actions. For example, if a button press expression definition is satisfied by a double tap of button 120, which causes a meeting to be joined in a mute mode, text 130 may describe that a double tap of button 120 will cause the pending meeting to be joined in a mute mode. If the notification state changes, a new text description 130 may describe the one or more new button press expression definitions and corresponding actions. For example, if a button press expression definition is satisfied by a long press of button 120 while the user gestures a thumbs-up sign to video camera 119, and if the corresponding action plays a missed voicemail on speakerphone, text 130 may describe that the user can play the missed voicemail on speakerphone by long-pressing button 120 while making a thumbs-up gesture in view of video camera 119.

Audio 112 may include audio provided by application 114 or voice assistant 115 for broadcast by speaker 118, such as notification audio prompt 132 or voice assistant response 136. Audio 112 may also include audio captured by microphone 116 and transmitted to application 114, such as voice assistant command 134. In other configurations, audio 112 includes bidirectional audio of a telephone call, video call, meeting, or other interactive audio experience.

Notification audio prompt 132, for example, may alert a user that the notification state of peripheral device 102 has changed. For instance, notification audio prompt 132 may alert the user that a meeting will begin in 15 minutes. This notification may be in the form of a spoken alert, such as a synthesized voice stating that “your meeting with Julia begins in 15 minutes.” However, the notification audio prompt may also be a tone, such as a “ding”. In some configurations, notification audio prompt 132 may also convey instructions on how to respond to the current notification state. For example, notification audio prompt 132 may tell the user that a single short button press 138 will cause the meeting to be joined 140.

Additionally, or alternatively, audio 112 may facilitate use of a voice assistant 115 via peripheral device 102. In some configurations, voice assistant 115 is a feature of application 114, while in other configurations, voice assistant 115 is provided by a different application, or the operation system, of computing device 104. Voice assistant 115 has compute and network connectivity requirements greater than those provided by peripheral device 102. As such, leveraging peripheral device 102 to control voice assistant 115 may extend the range at which voice assistant 115 may be used without the additional cost a computing device capable of operating voice assistant 115. Furthermore, peripheral device 102 provides a simplified interface to activate voice assistant 115, particularly when voice assistant 115 is one of many features included in application 114. For example, instead of a user moving to their desk, opening their computer, opening application 114, and finding the icon or menu item associated with voice assistant 115, peripheral device 102 enables direct access to voice assistant 115 via button 120.

In some configurations, voice assistant command 134 includes audio captured by microphone 116 and transmitted from peripheral device 102 to voice assistant 115 of application 114. For example, a voice assistant command 134 may ask that attendees of the user's upcoming meeting be notified that the user will be 15 minutes late. In some configurations, peripheral device 102 captures and transmits voice assistant command 134 in response to receiving a button press sequence that satisfies a particular button press expression definition 126, such as a single long button press. In some configurations, this button press expression definition 126 may operate independent of the current notification state. For example, whether the peripheral device 102 is in a meeting notification state, missed voicemail notification state, a default state, or the like, the button press expression definition 126 associated with voice assistant 115 may allow the user to send a voice assistant command 134. In some configurations, in response to registering a button press sequence satisfying the button press expression definition 126 associated with voice assistant 115, the user is presented with a prompt to speak the voice assistant command 134, e.g. an audio alert, activating a light on button 120, etc.

In some configurations, peripheral device 102 will capture and transmit a voice assistant command 134 as long as the button press sequence continues to be active (e.g. button 120 is held down). However, other configurations are similarly contemplated, such as capturing and transmitting a voice command 134 until a complete command has been received, or until the user has stopped talking for a defined period of time. Peripheral device 102 may begin transmitting voice assistant command 134 before the user has finished giving the command, allowing voice assistant 115 to begin processing voice assistant command 134 as soon possible.

Audio 112 may also include a voice assistant response 136. Voice assistant response 136 may be any audio generated by voice assistant 115 in response to a voice assistant command 134. For example, voice assistant response 136 may include a synthesized voice stating, “the participants of your 4 PM meeting have been notified that you'll be 15 minutes late”.

Some or all of the actions described above in conjunction with FIG. 1 may be performed by computing device 104, e.g. by software application 114. In this configuration, peripheral device 102 may perform user interface functionality, while computing device 104 manages the process and performs the requested actions. For example, peripheral device 102 may forward button press signals, exchange audio signals, and display text, while computing device 104 identifies button press sequences that satisfy button press expression definitions 126, determines which actions to invoke, interacts with a voice assistant, joins a meeting, and performs other processing functions. In other configurations, some or all of the functionality described above in conjunction with FIG. 1 may be performed by peripheral device 102. For example, in addition to the user interface functionality, peripheral device 102 may identify button press sequences that satisfy button press expression definitions 126, determine a corresponding action to take, and otherwise manage the process. In some configurations, peripheral device 102 and computing device/software application 114 share management of the process and/or perform different amounts of functionality, e.g. peripheral device 102 stores and identifies button press expressions, while software application 114 determines which action to take in response to a button press expression.

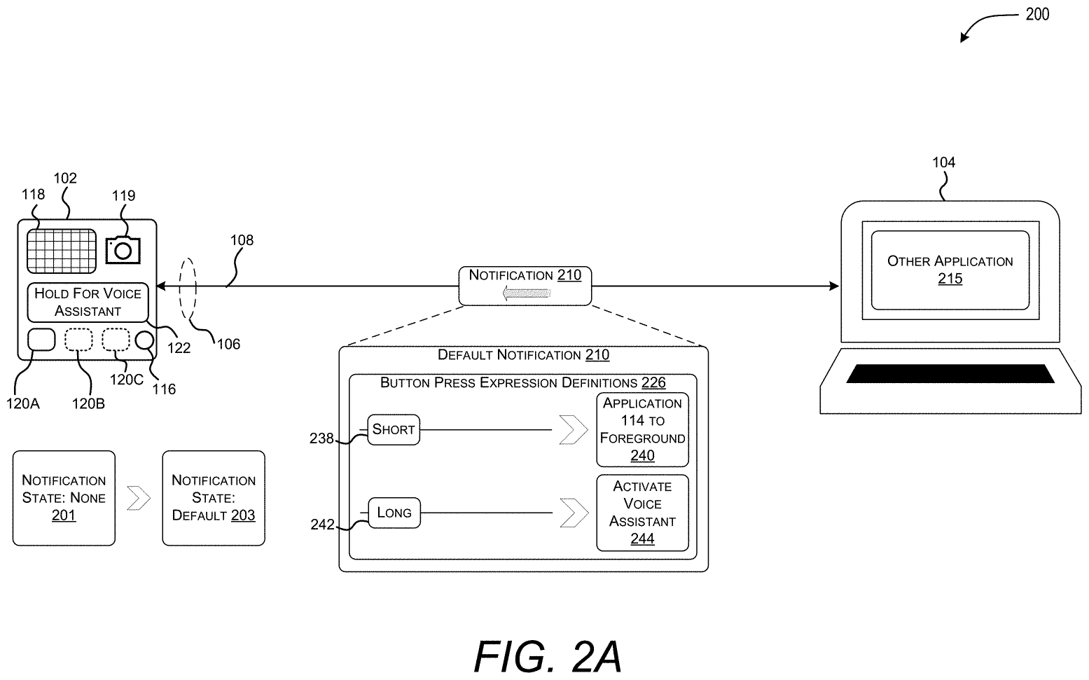

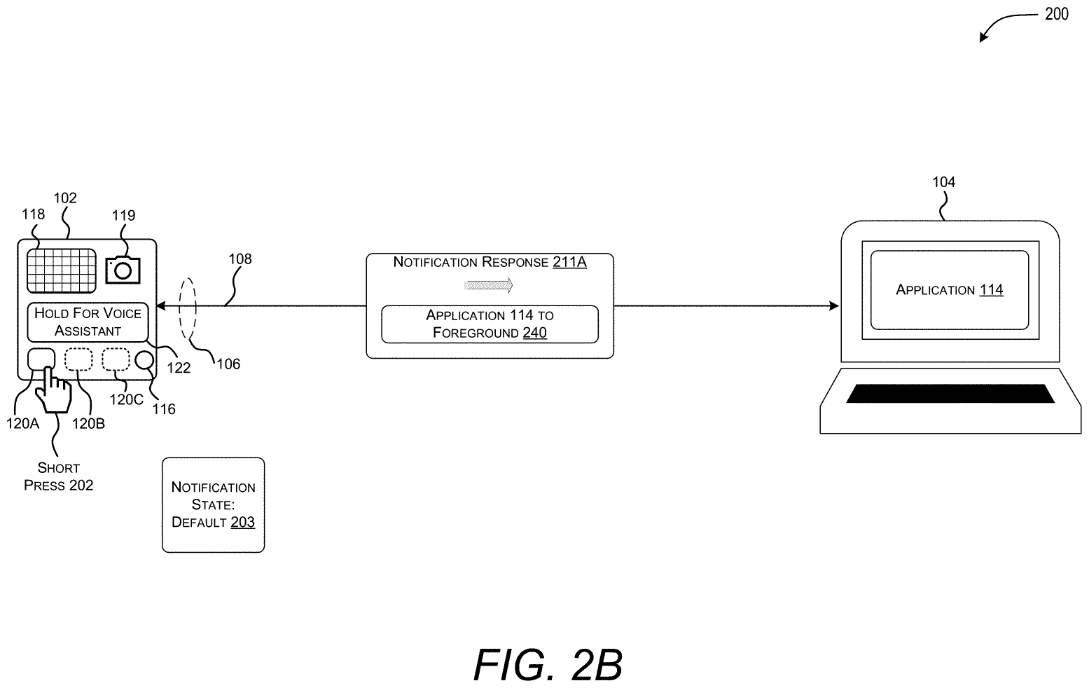

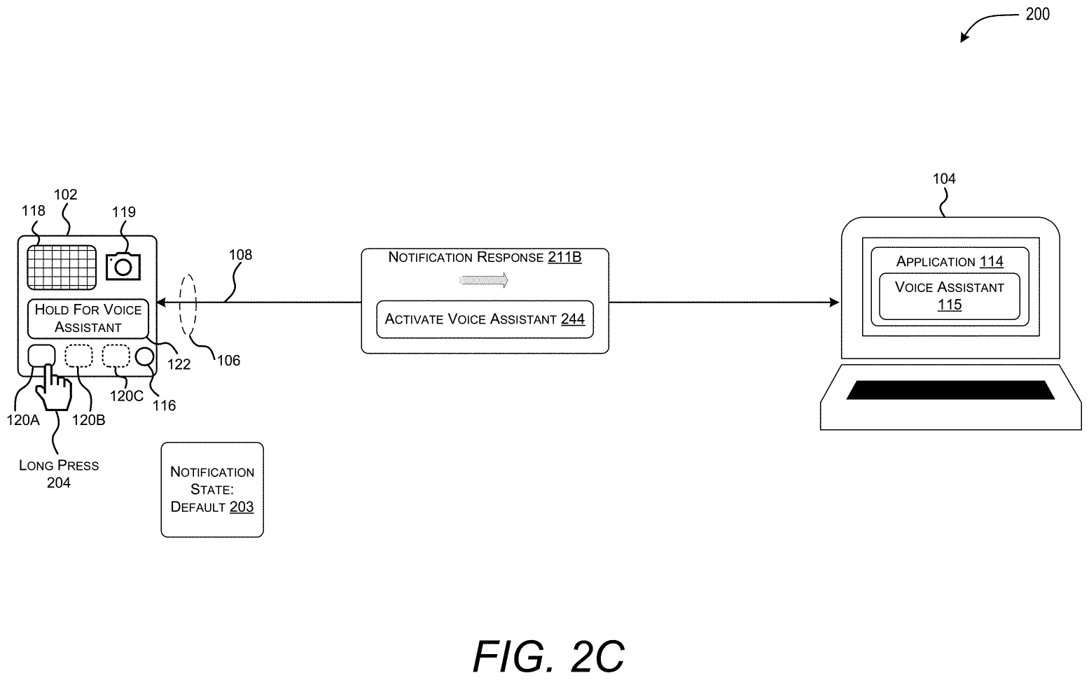

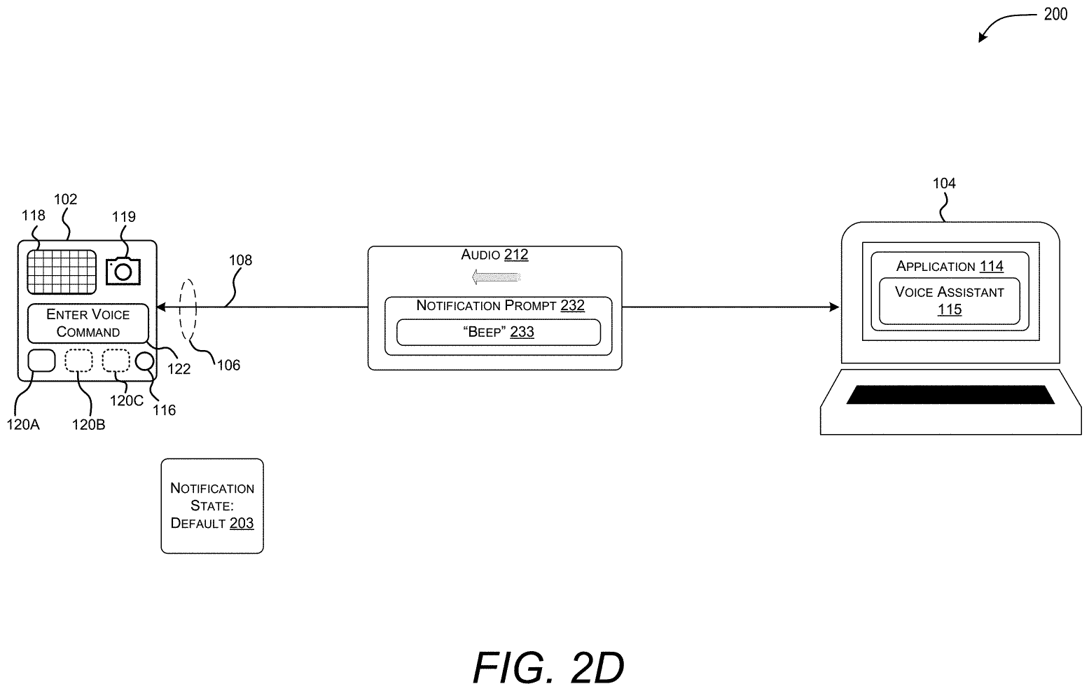

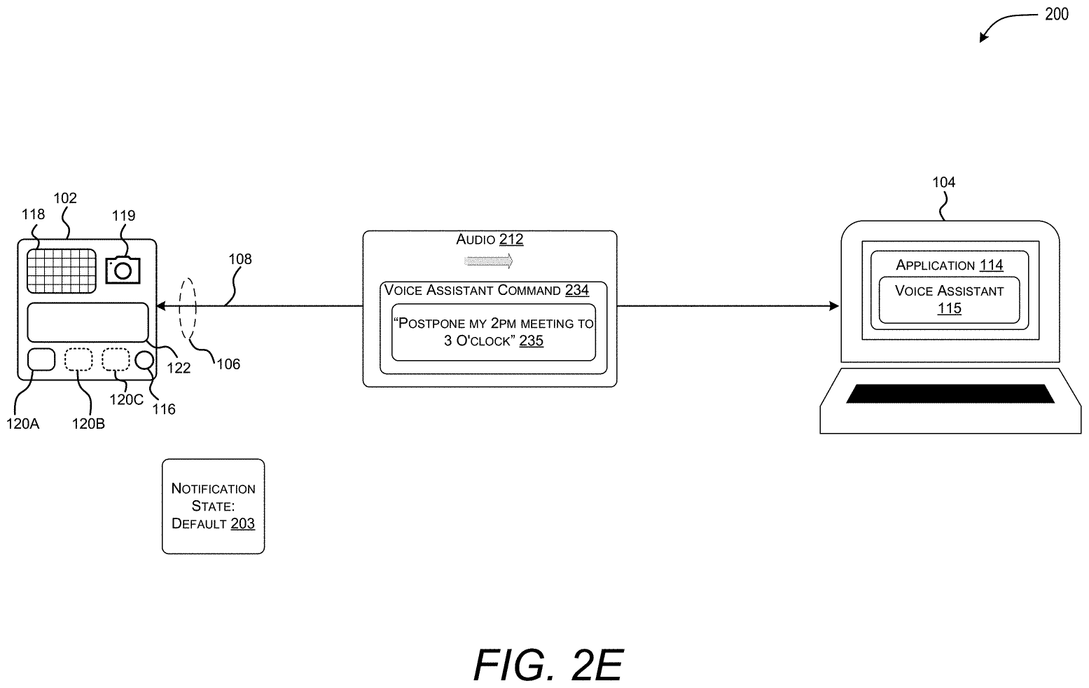

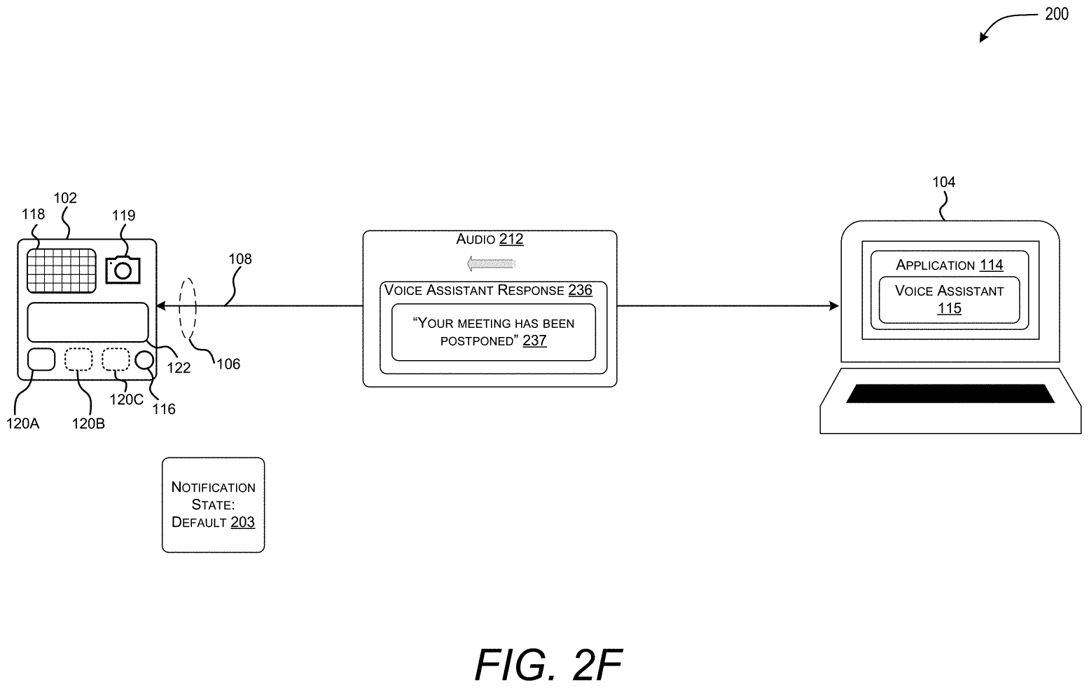

FIG. 2A illustrates operation of an exemplary communication session arrangement 200 that includes a software application 114 sending a notification message 110 to peripheral device 102, causing peripheral device 102 to enter a default state 203. In some configurations, peripheral device 102 enters default state 203 after not being in any state 201. Peripheral device 102 may not be in any state before being powered on, before being connected to computing device 104, and/or before being associated with application 114.

In some configurations, software application 114 is running in the background, e.g. it is minimized, running as a service, running in a system tray, occluded by other application 215, partially or completely off-screen, or otherwise not visible to the user. By running in the background, software application 114 is more difficult to access and utilize than if it was running in the foreground. For example, notifications, content changes, or other state changes that would otherwise be displayed by computing device 104 and discernable by a user at a glance, are hidden. The effect of not being able to view information displayed on software application 114 is greater when a user is situated away from computing device 104—e.g. if the user is situated closer to peripheral device 102 or across the room—and not able to quickly bring software application 114 to the foreground using a keyboard, mouse, or other input device. As such, the function of computing device 104 is improved by the ability to remotely cause software application 114 to be brought to the foreground of computing device 104 using a sequence of button presses that satisfy button press expression definition 238 or the like.

In some configurations, software application 114 generates and transmits notification 210 to peripheral device 102. Notification 210 may be a default notification in that it defines one or more button press expression definitions 226 and corresponding actions that are operative when peripheral device 102 isn't in another state. For example, application 114 may later cause peripheral device 102 to enter a “join meeting” state, which includes a different set of button press expression definitions and corresponding actions. But when the “join meeting” state ends, peripheral device may automatically return to the default state, allowing button press expression definitions 226 to be active again.

Button press expression definition 238 defines a short press as causing application 114 to perform action 240: bringing application 114 into the foreground. Bringing application 114 into the foreground may include restoring, maximizing, opening, and/or moving application 114 so as to make application 114 visible on computing device 104. Bringing application 114 into the foreground may also give application 114 focus, such that any subsequent user input will be processed by application 114. In the context of a multi-user communication technology application, a user may bring application 114 into the foreground to view meeting notes, view meeting participant presence information, view a video stream or shared desktop, schedule a meeting, associate a document with a meeting, etc. However, other types of applications will have their own advantageous reasons for being brought to the foreground.

Button press expression definition 242 defines a single long press as causing activate voice assistant action 244. Causing a voice assistant to activate allows a user of peripheral device 102 to utilize a voice assistant without having to be in range of a microphone 116 of computing device 104.

In some configurations, a button press expression definition remains active during other notification states. Button press expression definitions may be configured to remain active when other notification states do not include a button press expression definition with the same pattern. For example, if the default state is followed by a “join meeting” notification state, and the “join meeting” notification state does not include a button press expression definition with a single long press, button press expression definition 242 and corresponding action 244 may remain active. Additionally, or alternatively, a button press expression definition may be configured to remain active even if a subsequent notification state includes another button press expression definition with the same pattern. Maintaining a button press expression definition may be advantageous when the associated action is useful in many contexts, such as access to a voice assistant.

In some configurations, notification message 210 includes button light settings 128 and text descriptions 130 as discussed above in conjunction with FIG. 1. Button light settings 128 and text descriptions 130 may be used to alert the user that peripheral device 102 is in a default state.

FIG. 2B illustrates operation of the exemplary communication session arrangement 200 that includes peripheral device 102 in a default state 203 receiving a single short button press 202 and sending a notification response 211A to software application 114, causing software application 114 to bring itself into to the foreground. In some configurations, a user physically depresses button 120 longer than the minimum amount of time but less than the maximum amount of time defined by duration 148. This “short” button press causes peripheral device 102 to transmit notification response 211A to application 114. Notification response 211A may include “application 114 to foreground” action 240, which is associated with a single short button press by button press expression definition 238. When received by application 114, “application 114 to foreground” action 240 will cause application 114 to bring itself into the foreground of computing device 104. As discussed above, the user may then view information displayed by application 114 and/or utilize functionality provided by application 114.

FIG. 2C illustrates operation of the exemplary communication session arrangement 200 that includes peripheral device 102 in a default state 203 receiving single long button press 204 and sending notification response 211B to voice assistant 115 within application 114. In some configurations, long press 204 meets the criteria defined by button press expression definition 242. Button press expression definition 242 is associated with activate voice assistant action 244, and so upon detecting long press 204, peripheral device 102 transmits notification response 211B to initiate a voice assistant session with voice assistant 115.

FIG. 2D illustrates an optional operation of the exemplary communication session arrangement 200 that includes voice assistant 115 of application 114 transmitting a voice assistant notification prompt 232 to peripheral device 102. In some configurations, notification prompt 232 includes an audio prompt that when broadcast over speaker 118 alerts the user that voice assistant 115 is active and is ready to receive a voice command.

FIG. 2E illustrates operation of the exemplary communication session arrangement 200 that includes peripheral device 102 transmitting voice assistant command 234 to voice assistant 115 running within application 114. In some configurations voice assistant command 234 is captured with microphone 116 and may include any and all voice commands recognizable by a voice assistant 115. For example, the user may set an alarm, schedule a meeting with one or more colleagues, ask about her next appointment, initiate a telephone call, inquire about the weather, and the like. As depicted, voice assistant command 234 transmits request audio 235 containing “postpone my 2 PM meeting to 3 O'clock”.

FIG. 2F illustrates operation of the exemplary communication session arrangement 200 that includes voice assistant 115 transmitting voice assistant response 236 to peripheral device 102. Voice assistant response 236 may include audio 237 synthesized by voice assistant 115 to convey a response to the voice assistant command 234. For example, voice assistant response 236 may include an audio file 237 that, when played by speaker 118, alerts the user that “your meeting has been postponed”.

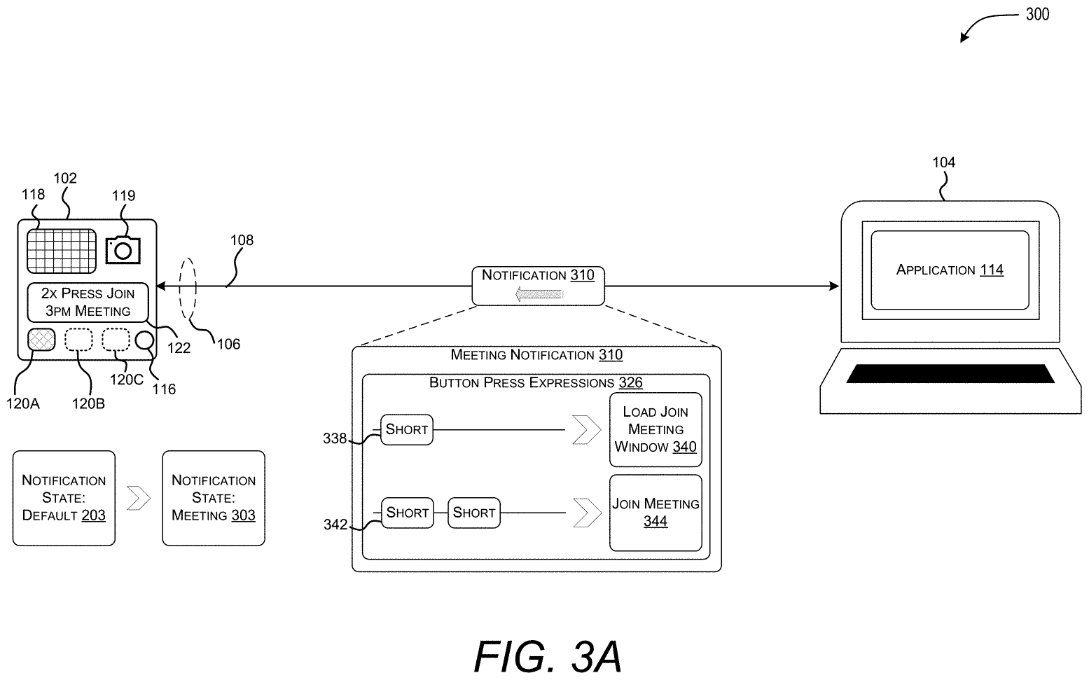

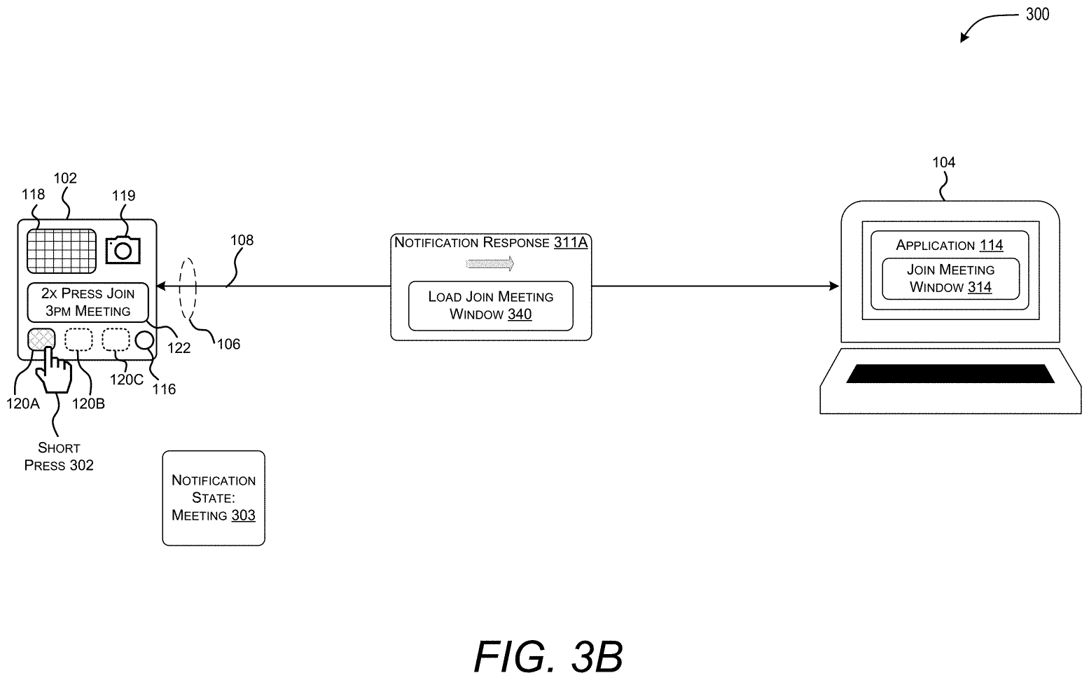

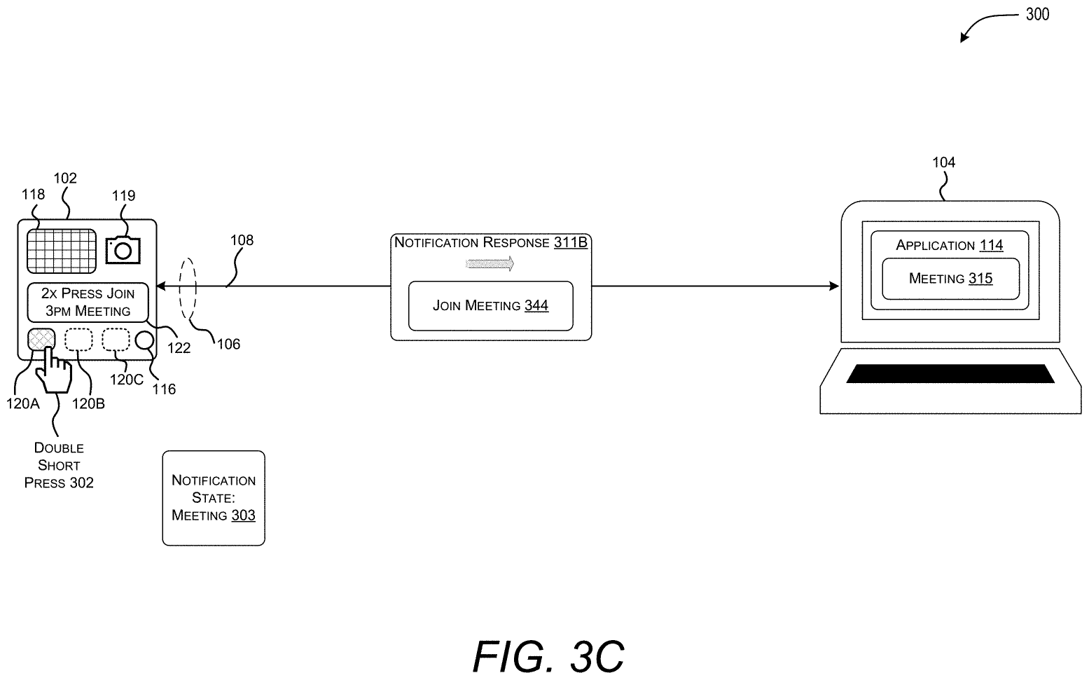

FIG. 3A illustrates operation of the exemplary communication session arrangement 300 that includes software application 114 sending notification message 310 to peripheral device 102, causing peripheral device 102 to enter a meeting notification state 303. In some configurations, peripheral device 102 transitions from default state 203 to meeting notification state 303, replacing some or all of the button press expression definitions 226 associated with default state 203.

In some configurations, software application 114 is running in the background, e.g. it is minimized, running as a service, running in a system tray, occluded by other application 215, partially or completely off-screen, or otherwise not visible to the user. In other configurations, application 114 is running in the foreground, e.g. displaying a home page, a calendar, a list of contacts, or the like.

In some configurations, software application 114 generates and transmits notification 310 to peripheral device 102. Notification 310 may be a meeting notification in that it defines one or more button press expression definitions 326 and corresponding actions that are relevant to an upcoming, ongoing, or recently completed meeting. Button press expression definitions 326 may be defined for different stages during the meeting notification state 303, as discussed above in conjunction with FIG. 1.

Button press expression definition 338 defines a short press as causing application 114 to perform action 340: displaying the “join meeting window” associated with the meeting. Displaying the “join meeting window” associated with the meeting enables the user to quickly enter an upcoming or ongoing meeting. Displaying the “join meeting window” also ensures that the user joins the correct meeting, and not a different meeting scheduled for the same time or a meeting scheduled for an earlier or later time.

Button press expression definition 342 defines a double short press as causing a join meeting action 344. Join meeting action 344 operates similar to load join meeting window action 340, except the user is joined to the meeting automatically. In this scenario, the user may beneficially join the meeting without interacting with application 114 or computing device 104, enabling the user to remain proximate to peripheral device 102.

In some configurations, notification message 310 includes button light settings 128 and text descriptions 130 as discussed above in conjunction with FIG. 1. Button light settings 128 and text descriptions 130 may be used to indicate that peripheral device is in a meeting notification state. Button light settings 128 and text descriptions 130 may also be used to convey information about the upcoming meeting, including a text description of when the meeting starts and/or patterned lights that increase in emphasis as the meeting draws closer.

FIG. 3B illustrates operation of exemplary communication session arrangement 300 that includes peripheral device 102 in meeting notification state 303 receiving a short button press 302 and sending notification response 311A to application 114, causing application 114 to open a join meeting window 314. In some configurations, opening the join meeting window 314 causes application 114 to enter a new state—a “in join meeting window” state. Application 114 may send a notification message 110 to peripheral device 102, causing peripheral device 102 to enter a “join meeting window” notification state. In one configuration, while in the “join meeting window” notification state, one of button press expression definitions 126 may cause the meeting to be joined outright. For example, one of button press expression definitions 126 may associate a single short press of button 120 with an action to join the meeting 315 associated with the join meeting window 314.

In some configurations, short button press 302 triggers button press expression definition 338, causing notification response 311A to include load join meeting window action 340. In some configurations, load join meeting window action 340 references a specific meeting, e.g. by including a meeting identifier. Application 114 may use the meeting identifier to open the join meeting window 314 associated with the specific meeting.

FIG. 3C illustrates operation of the exemplary communication session arrangement 300 that includes a peripheral device 102 in a meeting notification state 303 receiving a double short button press 304 and sending notification response 311 to application 114, causing application 114 to join a meeting 315. In some configurations, notification response 311 includes join meeting action 344. The join meeting action 344 may include a meeting identifier that was supplied by application 114 with notification 310, ensuring the correct meeting 315 was joined.

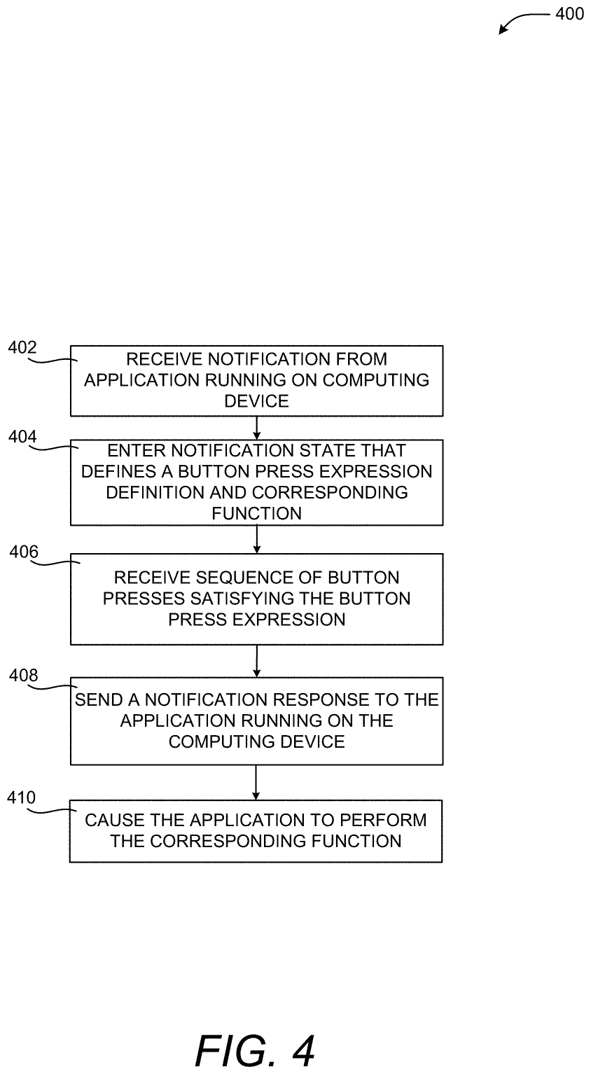

FIG. 4 is a diagram illustrating aspects of a routine 400 related to invoking desktop client skills with a peripheral audio device. For example, the routine 400 may be executed by the peripheral device 102 and/or the computing device 104. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Although the example routine described below is operating on a computing device, it can be appreciated that this routine can be performed on any computing system which may include a number of computers working in concert to perform the operations disclosed herein.

Thus, it should be appreciated that the logical operations described herein are implemented (1) as a sequence of computer implemented acts or program modules running on a computing system such as those described herein) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof. Additionally, the operations illustrated in FIG. 1-3 and the other FIGURES can be implemented in association with the example apparatuses and computing devices described herein.

The routine 400 begins at operation 402, where a notification 110 is received from an application 114 running on computing device 104. In some configurations, the notification includes one or more button press expression definitions 126, button light settings 128, and/or text descriptions 130.

At operation 404, the peripheral device 102 enters a notification state 303. Notification state 303 applies some or all of button press expression definitions 126, button light settings 128, and/or text descriptions 130 to peripheral device 102.

At operation 406, the peripheral device 102 receives a sequence of button presses satisfying the button press expression definition 126. In some configurations, the sequence of button presses are caused by pressing and releasing a button.

At operation 408, peripheral device 102 sends a notification response message 111 to the application 114 running on the computing device 104. In some configurations, the notification response message 111 includes an action, e.g. application to foreground 240, activate voice assistant 244, etc.

At operation 410, notification response message 111 causes application 114 to perform an action described by response message 111. For example, notification response 111 may cause application 114 to activate a voice assistant 115 of application 114. Additionally, or alternatively, notification response 111 may cause application to bring itself to the foreground of computing device 104, join a meeting, initiate a video call, or the like.

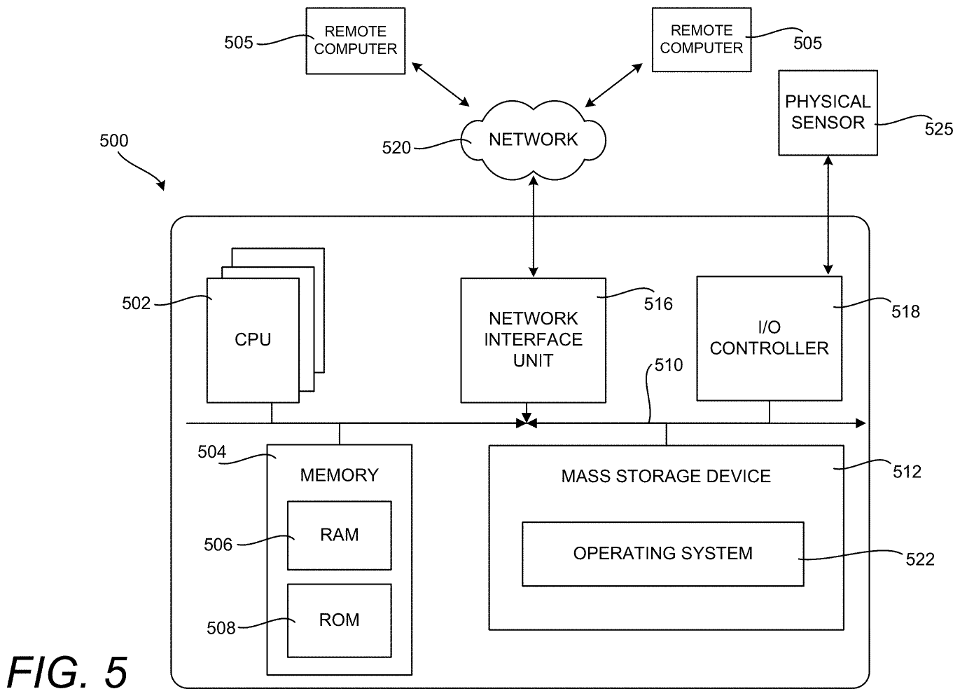

FIG. 5 is a computer architecture diagram showing an illustrative computer hardware and software architecture for a computing device 500 that can implement the various technologies presented herein. The computer hardware and software architecture for the computing device 500 can also be referred to herein as a “data processing system.” In particular, the architecture illustrated in FIG. 5 can be utilized to implement a server computer, mobile phone, an e-reader, a smartphone, a desktop computer, an AR/VR device, a tablet computer, a laptop computer, or another type of computing device. In some implementations, the peripheral device 102 and/or computing device 104 implement some or all of the elements and functionalities associated with the computing device 500.

The computer 500 illustrated in FIG. 5 includes a central processing unit 502 (“CPU”), a system memory 504, including a random-access memory 506 (“RAM”) and a read-only memory (“ROM”) 508, and a system bus 510 that couples the memory 504 to the CPU 502. A basic input/output system (“BIOS” or “firmware”) containing the basic routines that help to transfer information between elements within the computer 500, such as during startup, can be stored in the ROM 508. The computer 500 further includes a mass storage device 512 for storing an operating system 522, application programs, and other types of programs. The mass storage device 512 can also be configured to store other types of programs and data.

The mass storage device 512 is connected to the CPU 502 through a mass storage controller (not shown on FIG. 5) connected to the bus 510. The mass storage device 512 and its associated computer readable media provide non-volatile storage for the computer 500. Although the description of computer readable media contained herein refers to a mass storage device, such as a hard disk, CD-ROM drive, DVD-ROM drive, or USB storage key, it should be appreciated by those skilled in the art that computer readable media can be any available computer storage media or communication media that can be accessed by the computer 500.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer readable media.

By way of example, and not limitation, computer storage media can include volatile and non-volatile, removable and non-removable media implemented in any method or technology for storage of information such as computer readable instructions, data structures, program modules or other data. For example, computer storage media includes, but is not limited to, RAM, ROM, EPROM, EEPROM, flash memory or other solid-state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computer 500. For purposes of the claims, the phrase “computer storage medium,” and variations thereof, does not include waves or signals per se or communication media.

According to various configurations, the computer 500 can operate in a networked environment using logical connections to remote computers through a network such as the network 520. The computer 500 can connect to the network 520 through a network interface unit 516 connected to the bus 510. It should be appreciated that the network interface unit 516 can also be utilized to connect to other types of networks and remote computer systems. The computer 500 can also include an input/output controller 518 for receiving and processing input from a number of other devices, including a keyboard, mouse, touch input, an electronic stylus (not shown in FIG. 5), or a physical sensor such as a video camera. Similarly, the input/output controller 518 can provide output to a display screen or other type of output device (also not shown in FIG. 5).

It should be appreciated that the software components described herein, when loaded into the CPU 502 and executed, can transform the CPU 502 and the overall computer 500 from a general-purpose computing device into a special-purpose computing device customized to facilitate the functionality presented herein. The CPU 502 can be constructed from any number of transistors or other discrete circuit elements, which can individually or collectively assume any number of states. More specifically, the CPU 502 can operate as a finite-state machine, in response to executable instructions contained within the software modules disclosed herein. These computer-executable instructions can transform the CPU 502 by specifying how the CPU 502 transitions between states, thereby transforming the transistors or other discrete hardware elements constituting the CPU 502.

Encoding the software modules presented herein can also transform the physical structure of the computer readable media presented herein. The specific transformation of physical structure depends on various factors, in different implementations of this description. Examples of such factors include, but are not limited to, the technology used to implement the computer readable media, whether the computer readable media is characterized as primary or secondary storage, and the like. For example, if the computer readable media is implemented as semiconductor-based memory, the software disclosed herein can be encoded on the computer readable media by transforming the physical state of the semiconductor memory. For instance, the software can transform the state of transistors, capacitors, or other discrete circuit elements constituting the semiconductor memory. The software can also transform the physical state of such components in order to store data thereupon.

As another example, the computer readable media disclosed herein can be implemented using magnetic or optical technology. In such implementations, the software presented herein can transform the physical state of magnetic or optical media, when the software is encoded therein. These transformations can include altering the magnetic characteristics of particular locations within given magnetic media. These transformations can also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer 500 in order to store and execute the software components presented herein. It also should be appreciated that the architecture shown in FIG. 5 for the computer 500, or a similar architecture, can be utilized to implement other types of computing devices, including hand-held computers, video game devices, embedded computer systems, mobile devices such as smartphones, tablets, and AR/VR devices, and other types of computing devices known to those skilled in the art. It is also contemplated that the computer 500 might not include all of the components shown in FIG. 5, can include other components that are not explicitly shown in FIG. 5, or can utilize an architecture completely different than that shown in FIG. 5.

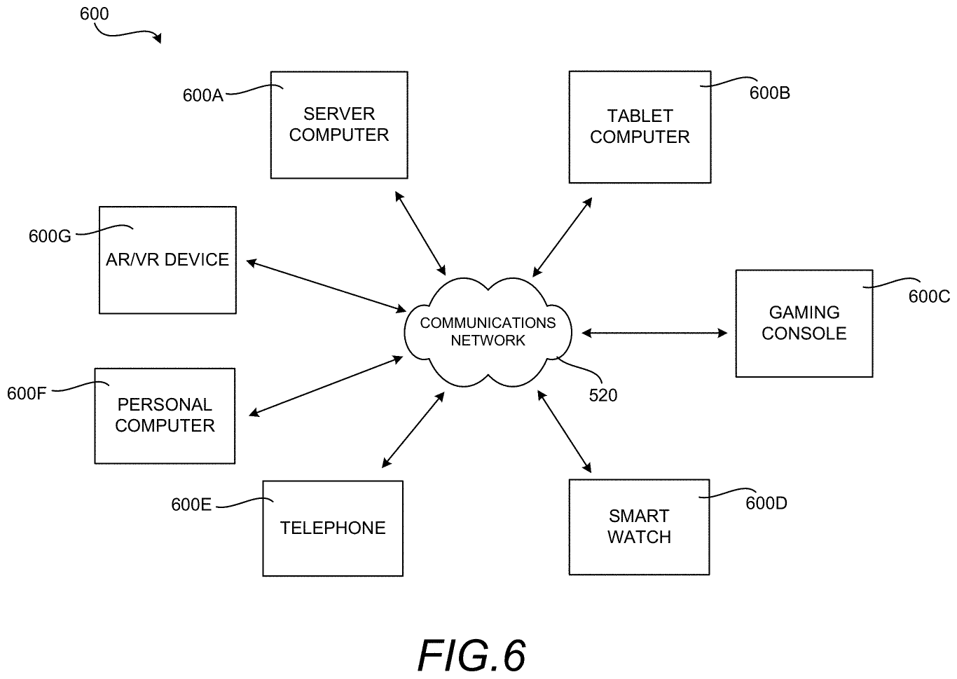

FIG. 6 is a network diagram illustrating a network computing environment 600 in which aspects of the disclosed technologies can be implemented, according to various embodiments presented herein. The network computing environment 600 can also be referred to herein as a “data processing system.” The peripheral device 102 and/or the computing device 104 may implement or couple to the distributed network computing environment 600.

As shown in FIG. 6, one or more server computers 600A can be interconnected via a communications network 520 (which may be either of, or a combination of, a fixed-wire or wireless LAN, WAN, intranet, extranet, peer-to-peer network, virtual private network, the Internet, Bluetooth communications network, proprietary low voltage communications network, or other communications network) with a number of client computing devices such as, but not limited to, a tablet computer 600B, a gaming console 600C, a smart watch 600D, a telephone 600E, such as a smartphone, a personal computer 600F, and an AR/VR device 600G.

In a network environment in which the communications network 520 is the Internet, for example, the server computer 600A can be a dedicated server computer operable to process and communicate data to and from the client computing devices 600B-600G via any of a number of known protocols, such as, hypertext transfer protocol (“HTTP”), file transfer protocol (“FTP”), or simple object access protocol (“SOAP”). Additionally, the networked computing environment 600 can utilize various data security protocols such as secured socket layer (“SSL”) or pretty good privacy (“PGP”). Each of the client computing devices 600B-600G can be equipped with an operating system operable to support one or more computing applications or terminal sessions such as a web browser (not shown in FIG. 6), or other graphical user interface (not shown in FIG. 6), or a mobile desktop environment (not shown in FIG. 6) to gain access to the server computer 600A.

The server computer 600A can be communicatively coupled to other computing environments (not shown in FIG. 6) and receive data regarding a participating user's interactions/resource network. In an illustrative operation, a user (not shown in FIG. 6) may interact with a computing application running on a client computing device 600B-600G to obtain desired data and/or perform other computing applications.

The data and/or computing applications may be stored on the server 600A, or servers 600A, and communicated to cooperating users through the client computing devices 600B-600G over an exemplary communications network 520. A participating user (not shown in FIG. 6) may request access to specific data and applications housed in whole or in part on the server computer 600A. These data may be communicated between the client computing devices 600B-600G and the server computer 600A for processing and storage.

The server computer 600A can host computing applications, processes and applets for the generation, authentication, encryption, and communication of data and applications, and may cooperate with other server computing environments (not shown in FIG. 6), third party service providers (not shown in FIG. 6), network attached storage (“NAS”) and storage area networks (“SAN”) to realize application/data transactions.

It should be appreciated that the computing architecture shown in FIG. 5 and the distributed network computing environment shown in FIG. 6 have been simplified for ease of discussion. It should also be appreciated that the computing architecture and the distributed computing network can include and utilize many more computing components, devices, software programs, networking devices, and other components not specifically described herein.

### EXAMPLE CLAUSES

The disclosure presented herein encompasses the subject matter set forth in the following clauses.

### Example 1

A method to be performed by a data processing system, the data processing system executing an application that manages a meeting, comprising: communicating a notification message to a peripheral device, wherein the notification message includes a state of the meeting, wherein the notification message causes the peripheral device to enter a notification state that presents an indication of the state of the meeting, and wherein the notification message associates a number of button press expression definitions with one or more actions associated with the meeting; receiving a user input from the peripheral device comprising a sequence of button presses; determining that the sequence of button presses is consistent with a button press expression definition of the number of button press expression definitions, wherein the button press expression definition is associated with one of the one or more actions that causes the application to join the meeting in a predetermined mode; and in response to receiving the user input comprising the sequence of button presses, causing the application to join the meeting in the predetermined mode.

### Example 2

The method implemented on the data processing system according to Example 1, wherein the predetermined mode causes a speaker of the peripheral device to emanate an audio signal of the meeting, and wherein the predetermined mode deactivates a microphone of the peripheral device to allow entry to the meeting in a mute mode.

### Example 3

The method implemented on the data processing system according to Example 1, wherein the predetermined mode causes the application to present a video stream associated with the meeting on a display screen of the data processing system, wherein the predetermined mode causes a speaker of the peripheral device to emanate an audio signal of the meeting, and wherein the predetermined mode causes a microphone of the peripheral device to capture audio for transmission to another meeting participant.

### Example 4

The method implemented on the data processing system according to Example 1, wherein the predetermined mode enables or disables one or more of a microphone of the peripheral device, a speaker of the peripheral device, or one or more display screens associated with the data processing system.

### Example 5

The method implemented on the data processing system according to Example 1, wherein the sequence of button presses is consistent with a second button press expression definition associated with an action that causes the application to join the meeting in a second predetermined mode.

### Example 6

The method implemented on the data processing system according to Example 1, wherein the notification state of the peripheral device ends after a defined amount of time or when the meeting ends.

### Example 7

The method implemented on the data processing system according to Example 6, wherein the peripheral device transitions from the notification state to a default state in response to the notification state ending.

### Example 8

A peripheral device, comprising: a microphone; and a controller programmed to: receive a notification message from a computing device; in response to receiving the notification message, entering a notification state, wherein the notification state defines a button press expression definition and a corresponding action executable to activate a voice assistant running on the computing device; receive a sequence of one or more button presses that satisfy the button press expression definition; and in response to receiving the sequence of one or more button presses that satisfy the button press expression definition, transmit a response notification message that activates the voice assistant running on the computing device.

### Example 9

The peripheral device according to Example 8, wherein the controller is further programmed to: transmit an audio signal defining a voice instruction provided by a user to the voice assistant; cause the voice assistant to perform a voice assistant operation; and receive an audio response to the voice assistant operation from the voice assistant.

### Example 10

The peripheral device according to Example 8, wherein the controller is further programmed to: receive a second notification message from the computing device; in response to receiving the second notification message from computing device, transition to a second notification state, wherein the second notification state defines a second action corresponding to the button press expression definition, and wherein the corresponding action retains priority over the second action.

### Example 11

The peripheral device according to Example 8, wherein the notification state was preceded by a default state, wherein the default state defined one or more button press expression definitions mapped to one or more corresponding actions executable by the computing device, and wherein the peripheral device transitions back to the default state after leaving the notification state.

### Example 12

The peripheral device of Example 11, wherein the notification message indicates that an application running on the computing device has entered an application state, and wherein the controller leaves the notification state in response to a second notification message from the computing device indicating that the application has left the application state.

### Example 13

The peripheral device of Example 12, wherein entering the application state indicates that the application has entered a meeting, and wherein leaving the application state indicates the meeting has ended, the meeting has been canceled, or the meeting has been rescheduled.

### Example 14

A system, comprising: means for receiving a notification message from a computing device; means for entering a notification state in response to receiving the notification message, wherein the notification state defines a button press expression definition and a corresponding action to run on the computing device; means for presenting an indication that the peripheral device is in the notification state; means for receiving a sequence of one or more button presses that satisfy the button press expression definition; and means for transmitting a response notification message that activates the action on the computing device, wherein the response notification message is transmitted in response to receiving the sequence of one or more button presses that satisfy the button press expression definition.

### Example 15

The system according to Example 14, wherein the notification state ends based on a defined amount of time expiring, receiving a second notification message from the computing device indicating that the notification state has ended, or receiving a third notification message from the computing device indicating that a new notification state has begun.

### Example 16

The system according to Example 14, wherein when the button press expression definition is not satisfied before a defined amount of time has expired, reverting from the notification state to a default state.

### Example 17

The system according to Example 16, wherein reverting from the notification state to the default state comprises: ceasing to present the indication that the peripheral device is in the notification state; and reverting to a button press expression definition and corresponding action associated with the default state.

### Example 18

The system according to Example 14, wherein the button press expression definition defines a sequence of one or more button presses of one or more durations.

### Example 19

The system according to Example 14, wherein the notification state comprises a plurality of stages, and wherein different button press expression definitions and corresponding functions are defined for one or more of the plurality of stages.

### Example 20

The system according to Example 14, wherein the notification state defines a pattern that alters the indication based on how close the notification state is to an end.

Although the techniques have been described in language specific to structural features and/or methodological acts, it is to be understood that the appended claims are not necessarily limited to the features or acts described. Rather, the features and acts are described as example implementations of such techniques.

It should be appreciated that the above-described subject matter may be implemented as a computer-controlled apparatus, a computer process, a computing system, or as an article of manufacture such as a computer-readable storage medium. Among many other benefits, the techniques herein improve efficiencies with respect to a wide range of computing resources. For instance, human interaction with a devices and systems may be improved as the use of the techniques disclosed herein enable users and individuals remotely manipulate rendered streams within a graphical environment associated with a communication session to better reflect their interactions in the communication session. Other technical effects other than those mentioned herein can also be realized from implementations of the technologies disclosed herein.

The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as FPGAs, DSPs, or other types of accelerators.

All of the methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples. All such modifications and variations are intended to be included herein within the scope of this disclosure and protected by the following claims.

1. A method to be performed by a data processing system, the data processing system executing an application that manages a meeting, comprising:
communicating a notification message to a peripheral device, wherein the notification message includes a state of the meeting, wherein the notification message causes the peripheral device to enter a notification state that presents an indication of the state of the meeting, and wherein the notification message associates a number of button press expression definitions with one or more actions associated with the meeting;
receiving a user input from the peripheral device comprising a sequence of button presses;
determining that the sequence of button presses is consistent with a button press expression definition of the number of button press expression definitions, wherein the button press expression definition is associated with one of the one or more actions that causes the application to join the meeting in a predetermined mode; and
in response to receiving the user input comprising the sequence of button presses, causing the application to join the meeting in the predetermined mode.

2. The method implemented on the data processing system according to claim 1, wherein the predetermined mode causes a speaker of the peripheral device to emanate an audio signal of the meeting, and wherein the predetermined mode deactivates a microphone of the peripheral device to allow entry to the meeting in a mute mode.

3. The method implemented on the data processing system according to claim 1, wherein the predetermined mode causes the application to present a video stream associated with the meeting on a display screen of the data processing system, wherein the predetermined mode causes a speaker of the peripheral device to emanate an audio signal of the meeting, and wherein the predetermined mode causes a microphone of the peripheral device to capture audio for transmission to another meeting participant.

4. The method implemented on the data processing system according to claim 1, wherein the predetermined mode enables or disables one or more of a microphone of the peripheral device, a speaker of the peripheral device, or one or more display screens associated with the data processing system.

5. The method implemented on the data processing system according to claim 1, wherein the sequence of button presses is consistent with a second button press expression definition associated with an action that causes the application to join the meeting in a second predetermined mode.

6. The method implemented on the data processing system according to claim 1, wherein the notification state of the peripheral device ends after a defined amount of time or when the meeting ends.

7. The method implemented on the data processing system according to claim 6, wherein the peripheral device transitions from the notification state to a default state in response to the notification state ending.

8. A peripheral device, comprising:
a microphone; and
a controller programmed to:
receive a notification message from a computing device;
in response to receiving the notification message, entering a notification state, wherein the notification state defines a button press expression definition and a corresponding action executable to activate a voice assistant running on the computing device;
receive a sequence of one or more button presses that satisfy the button press expression definition; and
in response to receiving the sequence of one or more button presses that satisfy the button press expression definition, transmit a response notification message that activates the voice assistant running on the computing device.

9. The peripheral device according to claim 8, wherein the controller is further programmed to:
transmit an audio signal defining a voice instruction provided by a user to the voice assistant;
cause the voice assistant to perform a voice assistant operation; and
receive an audio response to the voice assistant operation from the voice assistant.

10. The peripheral device according to claim 8, wherein the controller is further programmed to:
receive a second notification message from the computing device;
in response to receiving the second notification message from computing device, transition to a second notification state, wherein the second notification state defines a second action corresponding to the button press expression definition, and wherein the corresponding action retains priority over the second action.

11. The peripheral device according to claim 8, wherein the notification state was preceded by a default state, wherein the default state defined one or more button press expression definitions mapped to one or more corresponding actions executable by the computing device, and wherein the peripheral device transitions back to the default state after leaving the notification state.

12. The peripheral device of claim 11, wherein the notification message indicates that an application running on the computing device has entered an application state, and wherein the controller leaves the notification state in response to a second notification message from the computing device indicating that the application has left the application state.

13. The peripheral device of claim 12, wherein entering the application state indicates that the application has entered a meeting, and wherein leaving the application state indicates the meeting has ended, the meeting has been canceled, or the meeting has been rescheduled.

14. A system, comprising:
means for receiving a notification message from a computing device;
means for entering a notification state in response to receiving the notification message, wherein the notification state defines a button press expression definition and a corresponding action to run on the computing device;
means for presenting an indication that the peripheral device is in the notification state;
means for receiving a sequence of one or more button presses that satisfy the button press expression definition; and
means for transmitting a response notification message that activates the action on the computing device, wherein the response notification message is transmitted in response to receiving the sequence of one or more button presses that satisfy the button press expression definition.

15. The system according to claim 14, wherein the notification state ends based on a defined amount of time expiring, receiving a second notification message from the computing device indicating that the notification state has ended, or receiving a third notification message from the computing device indicating that a new notification state has begun.

16. The system according to claim 14, wherein when the button press expression definition is not satisfied before a defined amount of time has expired, reverting from the notification state to a default state.

17. The system according to claim 16, wherein reverting from the notification state to the default state comprises:
ceasing to present the indication that the peripheral device is in the notification state; and
reverting to a button press expression definition and corresponding action associated with the default state.

18. The system according to claim 14, wherein the button press expression definition defines a sequence of one or more button presses of one or more durations.

19. The system according to claim 14, wherein the notification state comprises a plurality of stages, and wherein different button press expression definitions and corresponding functions are defined for one or more of the plurality of stages.

20. The system according to claim 14, wherein the notification state defines a pattern that alters the indication based on how close the notification state is to an end.
